(19) United States
(12) Patent Application Publication
(10) Pub. No.: US 2022/0231707 A1
(43) Pub. Date: Jul. 21, 2022

(54) PROGRAMMABLE RADIO TIMING CONTROLLER

(71) Applicant: Analog Devices International Unlimited Company, Limerick (IE)

(72) Inventors: Alexander LEONARD, Raleigh, NC (US); Satishchandra G. RAO, Bangalore (IN); Christopher MAYER, Dover, MA (US); Brian Kenneth NEELY, Morrisville, NC (US)

(73) Assignee: Analog Devices International Unlimited Company, Limerick (IE)

(21) Appl. No.: 17/715,761

(22) Filed: Apr. 7, 2022

Related U.S. Application Data
(60) Provisional application No. 63/184,370, filed on May 5, 2021.

(51) Int. Cl. H04B 1/00; H04B 1/38

(52) U.S. Cl. CPC H04B 1/0003; H04B 1/38

(57) ABSTRACT

A radio timing controller equipped with one or more sequence controllers is disclosed. Sequence controllers enable high degree of programmability of the radio timing controller, e.g., in terms of the number of general purpose input/outputs (GPIOs), mapping of GPIOs to specific radio controls, setting of the radio control output states, timing to sequence events at radio symbol boundaries, etc.

### CROSS REFERENCE TO RELATED APPLICATIONS

This application is related to U.S. Provisional Patent Application No. 63/184,370, filed May 5, 2021, titled “PROGRAMMABLE RADIO TIMING CONTROLLER,” the disclosure of which is hereby incorporated by reference herein in its entirety.

### TECHNICAL FIELD OF THE DISCLOSURE

The present disclosure generally relates to radio frequency (RF) systems and, in particular, to timing controllers used in such systems.

### BACKGROUND

Radio systems are RF systems that transmit and receive signals in the form of electromagnetic waves in the RF range of approximately 3 kilohertz (kHz) to 300 gigahertz (GHz). Radio systems are commonly used for wireless communications, with satellite communications or cellular/wireless mobile communications being prominent examples. Modern integrated circuits (ICs) used in radio systems often contain multiple receive (Rx) and transmit (Tx) channels, together forming an RF transceiver (in the following, simply referred to as a “transceiver”), along with peripheral logic for more complex functions such as gain control, etc. To save power and avoid transmitting interference when not allowed, the transceiver should be able to power up and down these channels to a certain degree. A series of events is required within the transceiver to power up or power down a channel, where the timing of the individual events should align as tightly as possible with the regulated “air timing” of the system in which the transceiver is operating. This air timing is typically a product of the standard within which the entire radio system is operating (e.g., GSM, LTE, 5G, etc.). Certain standards have multiple operating modes (or numerologies). Therefore, it is valuable for a transceiver to have a large degree of flexibility and/or programmability in terms of the power sequence for the radio channels. Since a radio system is built with many more components than the transceiver, it is desirable to be able to control other hardware in the radio system in concert with the transceiver itself.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 provides a block diagram of a programmable radio timing controller implemented as a radio sequencer, according to some embodiments of the present disclosure.

FIG. 2 provides a block diagram of a radio sequencer with multiple sequence controllers, according to some embodiments of the present disclosure.

FIG. 3 provides a block diagram of a programmable radio timing controller with one or more sequence controllers, according to some embodiments of the present disclosure.

FIG. 4 provides a block diagram of a programmable radio timing controller within a radio system, according to some embodiments of the present disclosure.

FIG. 5 provides a block diagram of a sequence controller state machine, according to some embodiments of the present disclosure.

FIG. 6 illustrates example instruction format, according to some embodiments of the present disclosure.

FIG. 7 illustrates an example of an instruction field.

FIG. 8 illustrates an example of a multiframe that spans four frames.

FIG. 9 is a block diagram of an example system that may include a programmable radio timing controller, according to some embodiments of the present disclosure.

FIG. 10 is a block diagram of an example RF device that may include a programmable radio timing controller, according to some embodiments of the present disclosure.

FIG. 11 provides a block diagram illustrating an example data processing system that may be configured to control operation of a programmable radio timing controller, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating a programmable radio timing controller as described herein, it might be useful to first understand phenomena that may come into play in context of radio systems. The following foundational information may be viewed as a basis from which the present disclosure may be properly explained. Such information is offered for purposes of explanation only and, accordingly, should not be construed in any way to limit the broad scope of the present disclosure and its potential applications.

Previous generations of transceiver designs may have used general purpose in/outs (GPIOs) which were internally mappable to channel on/off triggers. This provided a fair amount of flexibility, but there were several drawbacks with this approach. This would be limited in the number of GPIOs available due to physical pin limitations and other functions which need GPIOs as well. The timing of GPIO triggers is inherently imprecise. Requiring many GPIOs for this function increases the complexity of board connections to the transceiver IC. Fewer GPIOs can be used (or more functions controlled) if some events are triggered via the main serial port interface (SPI), but SPI controls take more time to execute and end up being even more imprecise.

Embodiments of the present disclosure provide a radio timing controller equipped with one or more sequence controllers. Such sequence controllers enable high degree of programmability of the radio timing controller (i.e., make the radio timing controller programmable). In various aspects, a programmable radio timing controller described herein may provide an arbitrary number of GPIOs, programmable mapping of GPIOs to specific radio controls, programmable (and, possibly, repeatable) sequence to set the radio control output state, sufficiently fine timing to sequence events at radio symbol boundaries (possibly with a programmable offset in increments on the nanosecond scale), ability to dynamically modify the control sequence to various degrees (e.g., switch sequences entirely for a given output control, change values for parameters such as symbol duration between events, turning the sequencing on and off, modification queued to standard timing boundary such as multiframe boundary, etc.), synchronization of programmable sequences to an external signal indicating the higher-level air timing (e.g., multi-chip synchronization (MCS), which allows multiple chips with the same sequences to execute control evens at substantially the same time; or an alternative to MCS, which includes tracking periodic input GPIO signal, which may come in relation to the SSB_SYNC of the higher-level radio system), and ability to offset operation periodically to account for aperiodic symbol timing in the radio standard due to extended cyclic prefixes (CP).

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

As will be appreciated by one skilled in the art, aspects of the present disclosure, in particular aspects of a programmable radio timing controller as proposed herein, may be embodied in various manners, e.g., as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g., to the existing transceivers and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the select examples.

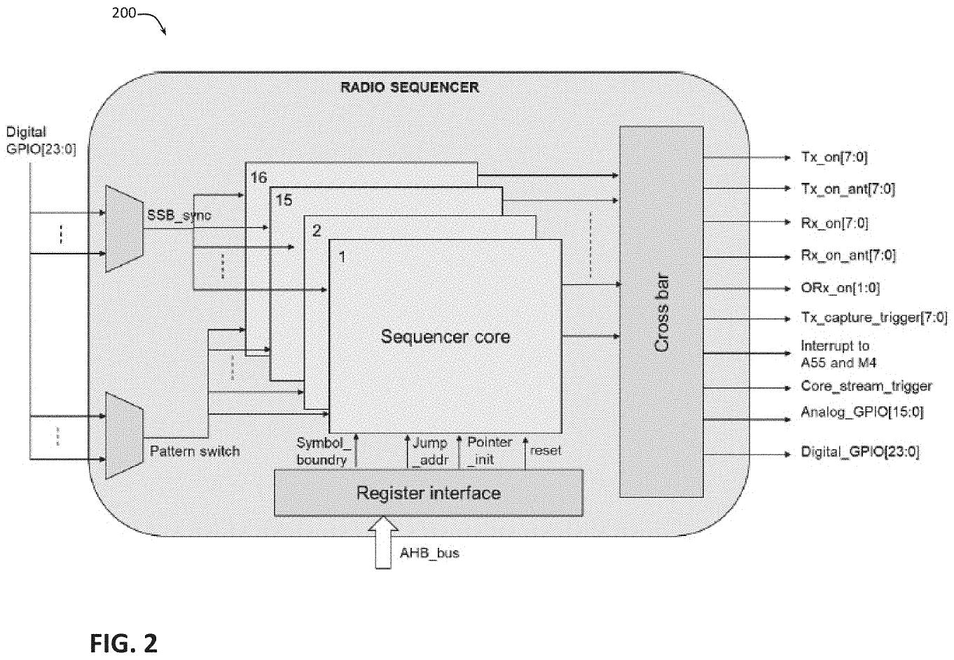

In the following description, reference is made to the drawings, where like reference numerals can indicate identical or functionally similar elements. It will be understood that elements illustrated in the drawings are not necessarily drawn to scale. Moreover, some embodiments can incorporate any suitable combination of features from two or more drawings. Further, it will be understood that certain embodiments can include more elements than illustrated in a drawing and/or a subset of the elements illustrated in a drawing. In general, while some drawings provided herein illustrate various aspects of a programmable radio timing controller, and systems in which such a programmable radio timing controller may be implemented, details of these systems may be different in different embodiments. For example, various components of a programmable radio timing controller, presented herein, may have further components included therein, or coupled thereto, which are not specifically shown in the drawings, such as logic, storage, passive elements (e.g., resistors, capacitors, inductors, etc.), or other elements (e.g., transistors, etc.). In another example, details shown in some of the drawings, such as the particular arrangement and example implementation details of various components of programmable radio timing controllers, presented herein and/or the particular arrangement of coupling connections may be different in different embodiments, with the illustrations of the present drawings providing only some examples of how these components may be used together to realize a programmable radio timing controller. In yet another example, although some embodiments shown in the present drawings illustrate a certain number of components (e.g., a certain number of flip-flops shown in FIG. 2), it is understood that these embodiments may be implemented with any number of these components in accordance with the descriptions provided herein. Furthermore, although certain elements such as various elements of a programmable radio timing controller as described herein may be depicted in the drawings as communicatively coupled using a single depicted line, in some embodiments, any of these elements may be coupled by a plurality of conductive lines such as those that may be present in a bus, or when differential signals are involved.

The description may use the phrases “in an embodiment” or “in embodiments,” which may each refer to one or more of the same or different embodiments. Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner. Furthermore, for the purposes of the present disclosure, the phrase “A and/or B” or notation “A/B” means (A), (B), or (A and B), while the phrase “A, B, and/or C” means (A), (B), (C), (A and B), (A and C), (B and C), or (A, B, and C). As used herein, the notation “A/B/C” means (A, B, and/or C). The term “between,” when used with reference to measurement ranges, is inclusive of the ends of the measurement ranges.

Various aspects of the illustrative embodiments are described using terms commonly employed by those skilled in the art to convey the substance of their work to others skilled in the art. For example, the term “connected” means a direct electrical connection between the things that are connected, without any intermediary devices/components, while the term “coupled” means either a direct electrical connection between the things that are connected, or an indirect electrical connection through one or more passive or active intermediary devices/components. In another example, the terms “circuit” or “circuitry” (which may be used interchangeably) refer to one or more passive and/or active components that are arranged to cooperate with one another to provide a desired function. Sometimes, in the present descriptions, the term “circuit” may be omitted (e.g., a sequence controller circuit may be referred to simply as a “sequence controller,” etc.). Similarly, sometimes, in the present descriptions, the term “signal” may be omitted. If used, the terms “substantially,” “approximately,” “about,” “around,” etc., may be used to generally refer to being within +/−20% of a target value, e.g., within +/−10% of a target value, based on the context of a particular value as described herein or as known in the art.

Example Radio Sequencer

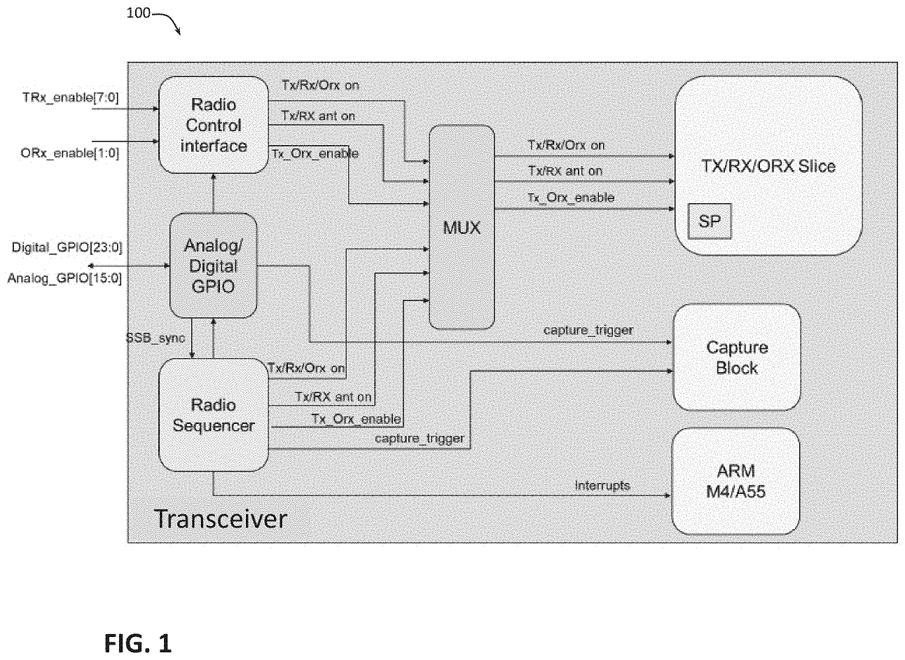

In some embodiments, a programmable radio timing controller may be implemented as a radio sequencer described with reference to FIGS. 1 and 2. A radio sequencer may be seen as a master timing controller in a transceiver which is in sync with system SSB sync. SSB sync is the timing reference from the system to make sure the frame timing across base stations are aligned over air to avoid interference between co-located base stations. FIG. 1 provides a block diagram of a radio sequencer 100, according to some embodiments of the present disclosure.

In previous generation transceivers all the controls for TX/RX/ORX channel enables and external triggers are from baseband processor through on chip GPIO, this required many GPIOs from BBP to TRX and take lot of board space. Generally, in any base station SSB_SYNC output which is the absolute reference for air timing is available and used to generate all the control signals that drive transceivers, external switches and PA control with respect to SSB_SYNC.

A transceiver according to an embodiment of the present disclosure may provide a legacy radio control interface along with a radio sequencer. The radio sequencer may be configured to take the SSB_SYNC as input and generate all the control signals required internally to transceiver, control external switches and PA control, termed as radio sequencer. The radio sequencer may be designed with a lot of flexibility to make sure customers can program complex sequences and save considerable number of pins as BBP needs to provide only SSB_SYNC and a dedicated GPIO to switch pattern if needed.

In general, a radio sequencer is a pattern generator with programmable period and timing. In various embodiments, it may support both 5G and 4G timing, including extended CP case. The radio sequencer may introduce a concept of multiframes for the convenience of the user. The actual SSB sync signal within a 5G frame (or the SSB_SYNC pin) might not correspond to a frame boundary and the period might span multi frames, it may be more useful to have pattern repetition aligned to frame boundaries as standard defines the timing in term of frames. A multiframe boundary may be defined with the same period as SSB_SYNC, but with an arbitrary phase offset to be chosen by the user. This may help to synchronize radio sequencer engines between multiple transceivers by using on chip MCS.

In some embodiments, the radio sequencer may be configured to operate in one of a plurality of modes to generate SSB sync signal by configuring few parameters, as explained below.

The first mode may be referred to as an “Internal SSB_SYNC mode.” In this mode, SSB sync is generated internally depending on the configuration done for symbol period, 4G or 5G standard and normal or extended CP. However, the external SSB sync signal may be required to measure the skew, this needs to be read back by BBP and adjusted to align multiple ADRV904x. This mode may provide automatic monitoring of subsequent SSB_SYNC pules. For every SSB_SYNC pulse, the skew may be latched and can be read back. However, there is no specific phase error calculation in hardware for the internal SSB_SYNC mode. Also, there is no tracking where the counter or phase is automatically adjusted. BBP may be needed to read this periodically and take corrective action. In some embodiments, in this mode, there is no status reporting for phase error between external and internal SSB sync.

The second mode may be referred to as an “External SSB_SYNC ONE SHOT mode.” In this mode, the external SSB sync may be used to align, the skew can be read back to adjust and align across multiple transceivers. In this mode, phase error between external and internal SSB sync may be provided as status when phase error is more than +/−1 ARM_CCLK. Reading back the status may clear this and reinitiate the one shot on next SSB sync.

The third mode may be referred to as an “External SSB_SYNC TRACKING mode.” In this mode, the initial sync with external SSB sync may be the same as one shot mode and the subsequent pulses may be used to track and shift the internal SSB sync to make sure the skew across the transceiver are maintained without intervention of BBP. This mode may be used to keep the radio timing aligned to the external system if the timing drift due to temperature changes and other system-wide considerations (e.g., global time updates, etc). Since the SSB_SYNC pin is not captured synchronously, exact determinism in frame timing is not possible. However, small changes in phase from the re-synchronized SSB_SYNC pin should not cause detrimental effects in the sequencer.

In some embodiments, the radio sequencer may also have a feature to switch pattern in run time and the new pattern will be applied on the next SSB sync. This can be used to switch to customer specific patterns for factory testing and calibration, in field antenna calibration.

FIG. 2 provides a block diagram of a programmable radio timing controller implemented as a radio sequencer 200 with multiple sequence controllers, according to some embodiments of the present disclosure. In some embodiments, the radio sequencer 200 may be a radio timing pattern generator based on a simple Very-Long-Instruction-Word (VLIW) instruction set. As shown in FIG. 2, in some embodiments, there may be 16 substantially identical sequence controllers driving 16 controls from each giving 256 controls which are multiplexed to all internal and external controls so that any sequencer o/p can be routed to any control. This very flexible feature to assign any sequencer output to any of the GPIO can be used for debugging and verification.

In some embodiments, a graphical user interface (GUI) may be used to configure required patterns for all the internal and external controls and then generate a binary which will be used by ARM M4, shown in FIG. 1, to configure the radio sequencer registers accordingly.

Sequence Controllers

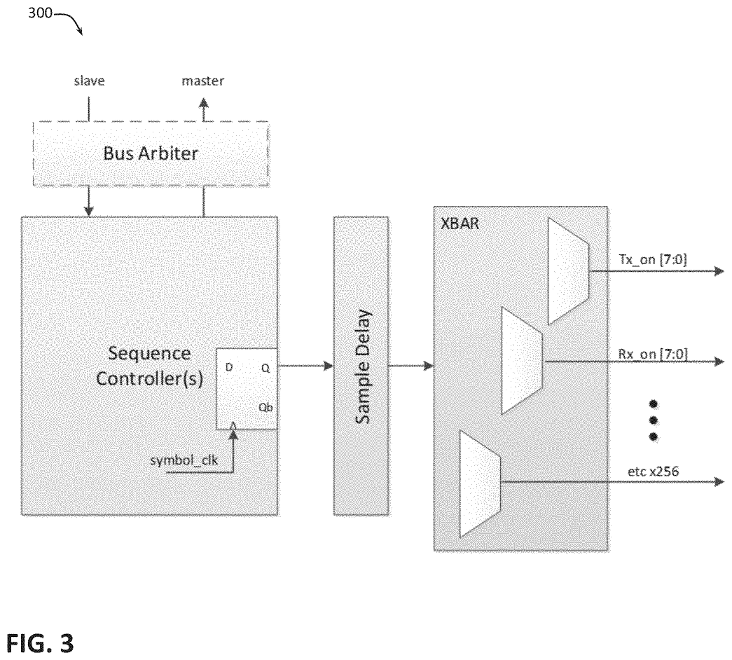

FIG. 3 provides a block diagram of a programmable radio timing controller 300 with one or more sequence controllers, according to some embodiments of the present disclosure.

The primary purpose of a sequence controller may be to fetch instructions from memory and use the fetched data to queue the next radio control value to be latched at a symbol boundary. In some embodiments, control toggling may be queued to symbol boundaries in order to provide a reliable and deterministic execution time from the sequence controller. In some embodiments, if running multiple sequences in parallel is supported, there may need to be multiple distinct sequence controllers in hardware. Alternatively, a single CPU could provide support (e.g., in software) for multiple parallel sequences.

Sample Delay

Since execution of the sequences is gated by symbol boundaries, it may make sense to implement fine sample delay offsets in a module external to the main sequence controller. At each symbol boundary, the desired radio control value along with the requested assertion delay can be registered and executed in the sample delay module.

Crossbar

In some embodiments, the crossbar (XBAR) may select which generic control wire from the sequencer should drive which real function (like channel on/off). It might also select which sequencer should be the source of the generic control wire if multiple sequence controllers are implemented. This function may be implemented in software if a more generic CPU architecture is implemented.

AHB Arbiter

In some embodiments, if multiple sequence controllers are physically implemented, it could be useful to arbitrate fetches onto a single bus to reduce complexity in higher level bus fabric.

### Example Implementation

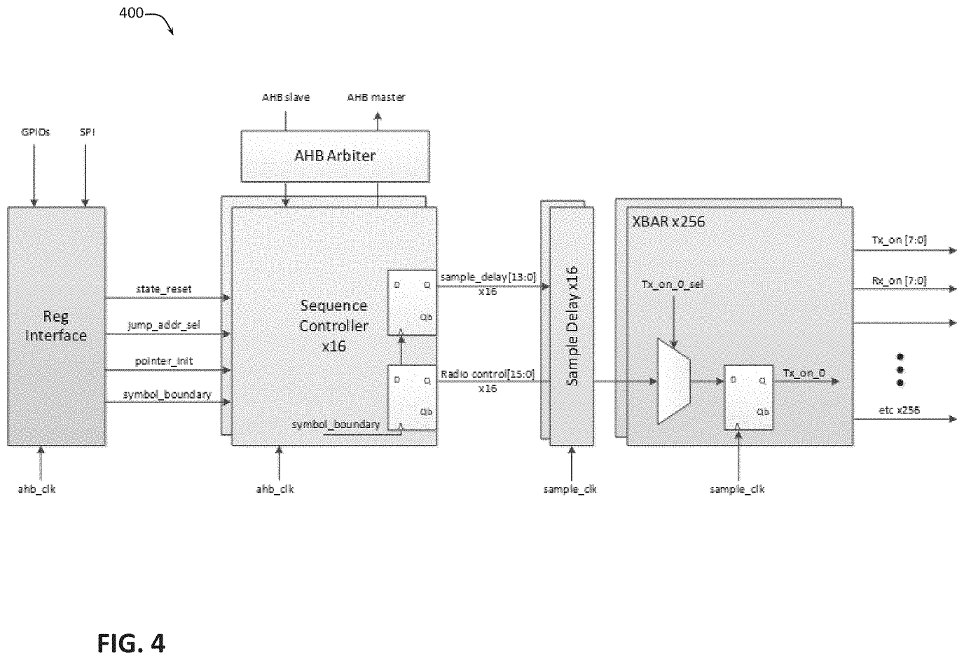

An example of a more detailed implementation of a programmable radio timing controller within a radio system is shown in FIG. 4.

Sequence Controller State Machine

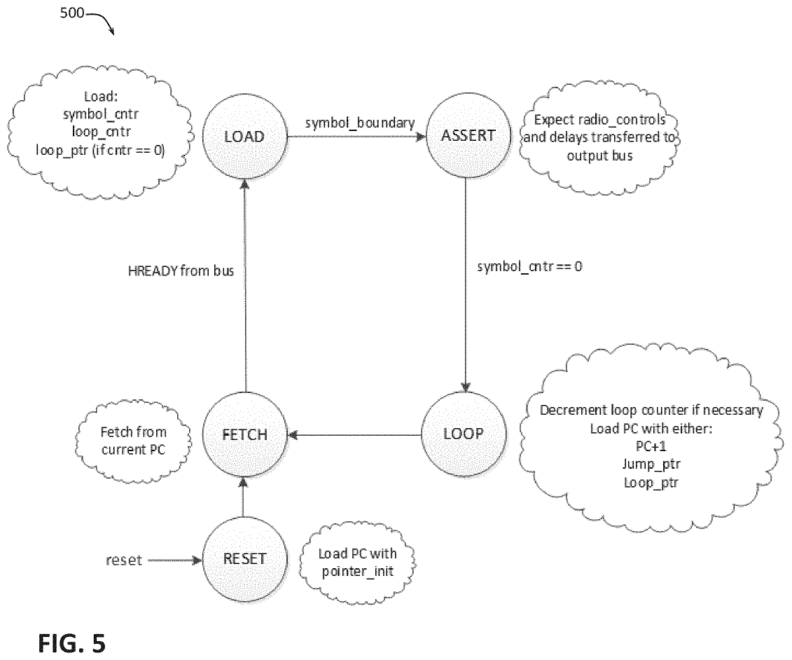

FIG. 5 provides a block diagram of a sequence controller state machine 500, according to some embodiments of the present disclosure.

Timing Synchronization: Multiframe

Since a radio frame in 4G/LTE and 5G is 10 ms, and there are events that may span multiple frames (such as digital predistortion (DPD) data collection), a concept of a multiframe is introduced for the purposes of synchronization. In some embodiments, a programmable radio timing controller may operate in one of two modes to synchronize the internal multiframe counter. One is an MCS mode and another one is a Pin mode.

Timing Synchronization: MCS Mode

In the MCS mode, the multiframe counter is synchronized when the transceiver is first powered on via an external reference signal (commonly referred to as SYSREF). This method of synchronization is highly accurate and will guarantee precise boundaries for radio control assertions.

Timing Synchronization: Pin Mode

In the Pin mode, the multiframe counter is synchronized to a periodic signal driving a GPIO pin. Small changes in phase (jitter) on this periodic input signal will cause similar changes in the radio control assertions. For certain applications, the jitter may be small enough such that this problem is outweighed by the benefit of more frequent re-synchronization.

Timing Synchronization: Configuration Updates

In some embodiments, the multiframe boundaries may allow the timing controller to queue configuration updates for a known point in time. For example, this could be useful if multiple radios need to switch to a new air timing scheme simultaneously to avoid interference. A different sequence of radio control toggles can be programmed in memory, or GPR values changed, on all radios at an unknown point in time. The changes can then later be queued to apply at the next multiframe boundary.

Timing Synchronization: Symbol Boundaries

In some embodiments, the internal state machine, and thus assertion of radio controls, may be tied to symbol boundaries. A symbol is the lowest level (highest frequency) set of information that is transmitted in modern radios since it is based directly on the employed modulation scheme. It is expected that most radio control events will correspond with particular symbol boundaries within a frame or set of frames. Aligning operation to symbol boundaries may allow for robust and precise manipulation of radio controls. The time within a symbol gives the controller an opportunity to prepare the next set of controls to be asserted on a precise symbol boundary. This may be useful due to the non-deterministic nature of the controller's internal operation.

In some embodiments, the symbol boundaries may be synchronized with the multiframe counter. Every end of a multiframe may reset the symbol counter directly.

Timing Synchronization: Extended CP

It may often be the case that a radio framing standard will not exactly fit an integer number of symbols within a frame. This may require the use of extended cyclic prefixes (CPs) to stretch symbols periodically. The radio timing controller may track this aperiodicity to avoid asserting control events asynchronous to air timing. The radio timing controller may have programmable width for the normal and extended symbols (both including CP) as well as the spacing between them.

Instruction Format

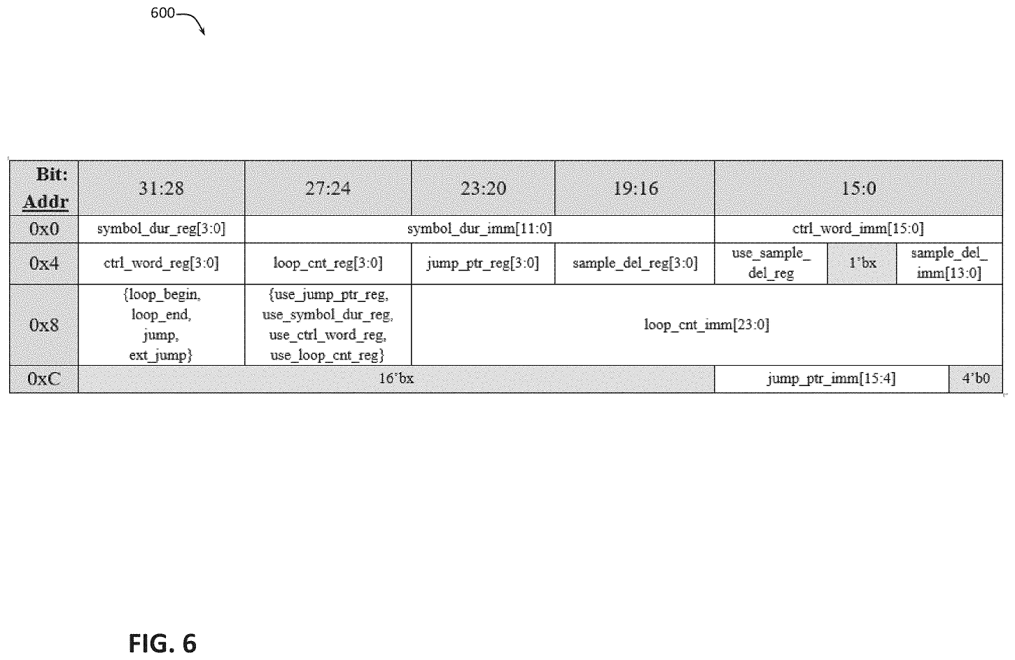

In some embodiments, the instructions may be formatted with very-long-instruction-width (VLIW). This may allow a single fetch to gather all the data associated with a radio control toggle without the need to string together multiple, simpler instructions. The hardware complexity is reduced from having all of this information available immediately after a single fetch. An example of instruction format is shown in FIG. 6.

Instruction Format: Looping

Looping is supported in order to more easily repeat the same sequence of instructions within a larger sequence. The loop_begin flag, coinciding with the loop_cnt, defines the first instruction in a loop as well as the number of loop iterations. The loop_end flag defines the last instruction in a loop.

Instruction Format: Jumping

Jumping is supported to repeat an entire sequence, idle within a single instruction, or move to a different sequence. After completing the radio control change and waiting for the specified symbol duration, the controller will start executing from the given jump pointer.

Instruction Format: Sample Delay

The sample_delay field is used to offset the assertion of a radio control by a more fine-grained amount. For example, a control toggle could occur on a particular symbol boundary plus 10 nanoseconds of delay.

Instruction Format: General Purpose Registers

General purpose registers (GPRs) allow a user to change the radio timing sequence without having to reprogram new instructions. A set of instructions is programmed to take values from particular GPRs, the value of which can be changed later via the SPI.

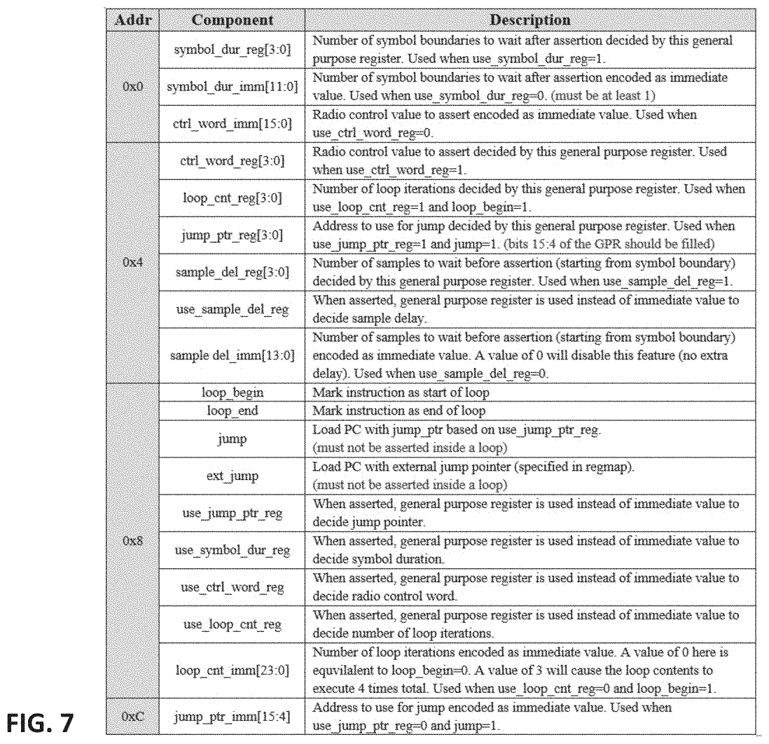

FIG. 7 illustrates an example of an instruction field.

### Example

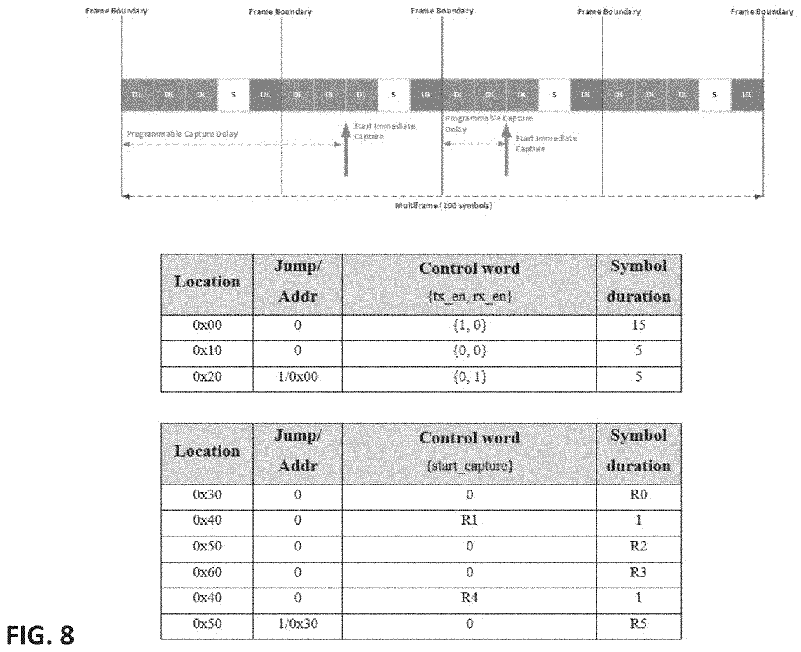

In the example shown in FIG. 8, a multiframe will span four frames. Basic radio operation is defined as three slots for downlink (DL), one slot for the guard region (S), and one slot for uplink (UL), which repeats in every frame. In addition, there are two programmable capture opportunities which may be useful for peripheral radio functions such as digital predistortion (DPD). These functions are split into two separate sequences which run separately on different controllers.

Use of GPRs

In some embodiments, GPRs 0-5 may be used in the second sequence to control the data captures. The user may turn on or off one or both of the captures using R1 or R4, and the user may change the timing of the capture with R0, R2, R3, and R5. For example, in FIG. 8, the first capture waiting period starts at the beginning of a multiframe (and thus the beginning of a sequence) with a duration programmed in R0. To make modifications easier, the user has chosen to always start the second capture waiting period (R3) at the second frame boundary. Thus, if the first capture location is changed, it will not affect the second. This requires a change in both R0 and R2 when the first capture location is changed.

Example Systems

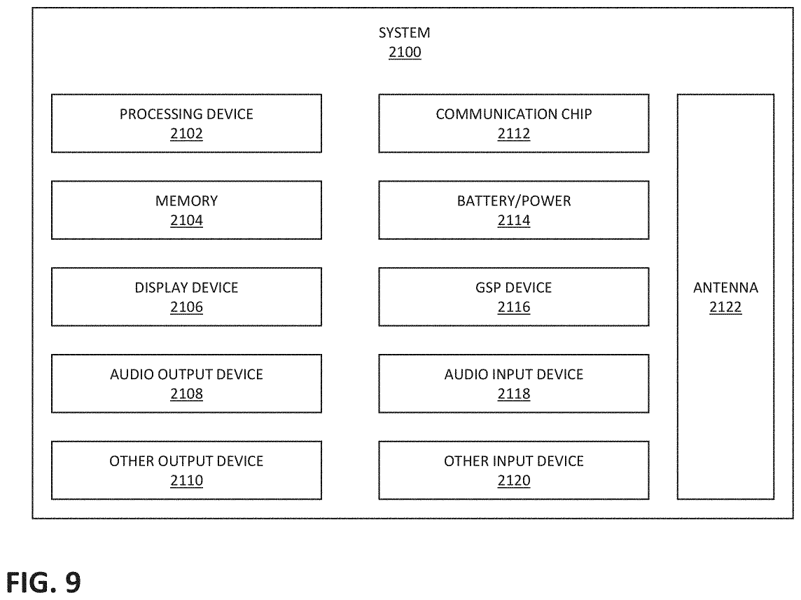

FIG. 9 is a block diagram of an example system 2100 that may include a programmable radio timing controller, in accordance with any of the embodiments disclosed herein. For example, any suitable ones of the components of the system 2100 may include one or more of the system 200 and/or the device 500 as disclosed herein. A number of components are illustrated in FIG. 9 as included in the system 2100, but any one or more of these components may be omitted or duplicated, as suitable for the application. In some embodiments, some or all of the components included in the system 2100 may be attached to one or more motherboards. In some embodiments, some or all of these components are fabricated onto a single system-on-a-chip (SOC) die.

Additionally, in various embodiments, the system 2100 may not include one or more of the components illustrated in FIG. 9, but the system 2100 may include interface circuitry for coupling to the one or more components. For example, the system 2100 may not include a display device 2106, but may include display device interface circuitry (e.g., a connector and driver circuitry) to which a display device 2106 may be coupled. In another set of examples, the system 2100 may not include an audio input device 2118 or an audio output device 2108 but may include audio input or output device interface circuitry (e.g., connectors and supporting circuitry) to which an audio input device 2118 or audio output device 2108 may be coupled.

The system 2100 may include a processing device 2102 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2102 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. The system 2100 may include a memory 2104, which may itself include one or more memory devices such as volatile memory (e.g., dynamic random access memory (RAM) (DRAM)), non-volatile memory (e.g., read-only memory (ROM)), flash memory, solid state memory, and/or a hard drive. In some embodiments, the memory 2104 may include memory that shares a die with the processing device 2102. This memory may be used as cache memory and may include embedded DRAM (eDRAM) or spin transfer torque magnetic RAM (STT-MRAM).

In some embodiments, the system 2100 may include a communication chip 2112 (e.g., one or more communication chips). For example, the communication chip 2112 may be configured for managing wireless communications for the transfer of data to and from the system 2100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2112 may operate in accordance with other wireless protocols in other embodiments. The system 2100 may include an antenna 2122 to facilitate wireless communications and/or to receive other wireless communications (such as AM or FM radio transmissions).

In some embodiments, the communication chip 2112 may manage wired communications, such as electrical, optical, or any other suitable communication protocols (e.g., the Ethernet). As noted above, the communication chip 2112 may include multiple communication chips. For instance, a first communication chip 2112 may be dedicated to shorter-range wireless communications such as Wi-Fi or Bluetooth, and a second communication chip 2112 may be dedicated to longer-range wireless communications such as global positioning system (GPS), EDGE, GPRS, CDMA, WiMAX, LTE, EV-DO, or others. In some embodiments, a first communication chip 2112 may be dedicated to wireless communications, and a second communication chip 2112 may be dedicated to wired communications.

The system 2100 may include battery/power circuitry 2114. The battery/power circuitry 2114 may include one or more energy storage devices (e.g., batteries or capacitors) and/or circuitry for coupling components of the system 2100 to an energy source separate from the system 2100 (e.g., AC line power).

The system 2100 may include a display device 2106 (or corresponding interface circuitry, as discussed above). The display device 2106 may include any visual indicators, such as a heads-up display, a computer monitor, a projector, a touchscreen display, a liquid crystal display (LCD), a light-emitting diode display, or a flat panel display.

The system 2100 may include an audio output device 2108 (or corresponding interface circuitry, as discussed above). The audio output device 2108 may include any device that generates an audible indicator, such as speakers, headsets, or earbuds.

The system 2100 may include an audio input device 2118 (or corresponding interface circuitry, as discussed above). The audio input device 2118 may include any device that generates a signal representative of a sound, such as microphones, microphone arrays, or digital instruments (e.g., instruments having a musical instrument digital interface (MIDI) output).

The system 2100 may include a GPS device 2116 (or corresponding interface circuitry, as discussed above). The GPS device 2116 may be in communication with a satellite-based system and may receive a location of the system 2100, as known in the art.

The system 2100 may include another output device 2110 (or corresponding interface circuitry, as discussed above). Examples of the other output device 2110 may include an audio codec, a video codec, a printer, a wired or wireless transmitter for providing information to other devices, or an additional storage device.

The system 2100 may include another input device 2120 (or corresponding interface circuitry, as discussed above). Examples of the other input device 2120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The system 2100 may have any desired form factor, such as a handheld or mobile electrical device (e.g., a cell phone, a smart phone, a mobile internet device, a music player, a tablet computer, a laptop computer, a netbook computer, an ultrabook computer, a personal digital assistant (PDA), an ultra-mobile personal computer, etc.), a desktop electrical device, a server device or other networked computing component, a printer, a scanner, a monitor, a set-top box, an entertainment control unit, a vehicle control unit, a digital camera, a digital video recorder, or a wearable electrical device. In some embodiments, the system 2100 may be any other electronic device that processes data.

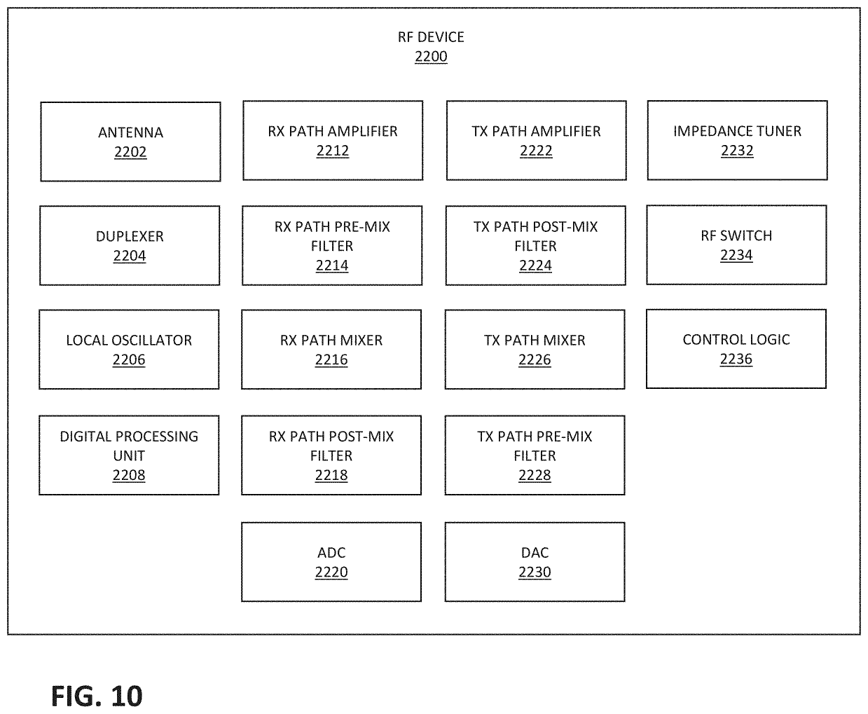

FIG. 10 is a block diagram of an example RF device 2200 that may include one or more components that may need to be synchronized using a programmable radio timing controller in accordance with any of the embodiments disclosed herein. In some embodiments, the RF device 2200 may be included within any components of the system 2100 as described with reference to FIG. 9 or may be coupled to any of the components of the system 2100, e.g., be coupled to the memory 2104 and/or to the processing device 2102 of the system 2100. In still other embodiments, the RF device 2200 may further include any of the components described with reference to FIG. 9, such as, but not limited to, the battery/power circuit 2114, the memory 2104, and various input and output devices as shown in FIG. 9.

In general, the RF device 2200 may be any device or system that may support wireless transmission and/or reception of signals in the form of electromagnetic waves in the RF range of approximately 3 kilohertz (kHz) to 300 gigahertz (GHz). In some embodiments, the RF device 2200 may be used for wireless communications, e.g., in a base station (BS) or a user equipment (UE) device of any suitable cellular wireless communications technology, such as GSM, WCDMA, or LTE. In a further example, the RF device 2200 may be used as, or in, e.g., a BS or a UE device of a millimeter-wave wireless technology such as fifth generation (5G) wireless (i.e., high-frequency/short wavelength spectrum, e.g., with frequencies in the range between about 20 and 60 GHz, corresponding to wavelengths in the range between about 5 and 15 millimeters). In yet another example, the RF device 2200 may be used for wireless communications using Wi-Fi technology (e.g., a frequency band of 2.4 GHz, corresponding to a wavelength of about 12 cm, or a frequency band of 5.8 GHz, spectrum, corresponding to a wavelength of about 5 cm), e.g., in a Wi-Fi-enabled device such as a desktop, a laptop, a video game console, a smart phone, a tablet, a smart TV, a digital audio player, a car, a printer, etc. In some implementations, a Wi-Fi-enabled device may, e.g., be a node in a smart system configured to communicate data with other nodes, e.g., a smart sensor. Still in another example, the RF device 2200 may be used for wireless communications using Bluetooth technology (e.g., a frequency band from about 2.4 to about 2.485 GHz, corresponding to a wavelength of about 12 cm). In other embodiments, the RF device 2200 may be used for transmitting and/or receiving RF signals for purposes other than communication, e.g., in an automotive radar system, or in medical applications such as magneto-resonance imaging (MRI).

In various embodiments, the RF device 2200 may be included in frequency-division duplex (FDD) or time-domain duplex (TDD) variants of frequency allocations that may be used in a cellular network. In an FDD system, the uplink (i.e., RF signals transmitted from the UE devices to a BS) and the downlink (i.e., RF signals transmitted from the BS to the US devices) may use separate frequency bands at the same time. In a TDD system, the uplink and the downlink may use the same frequencies but at different times.

A number of components are illustrated in FIG. 10 as included in the RF device 2200, but any one or more of these components may be omitted or duplicated, as suitable for the application. For example, in some embodiments, the RF device 2200 may be an RF device supporting both of wireless transmission and reception of RF signals (e.g., an RF transceiver), in which case it may include both the components of what is referred to herein as a transmit (TX) path and the components of what is referred to herein as a receive (RX) path. However, in other embodiments, the RF device 2200 may be an RF device supporting only wireless reception (e.g., an RF receiver), in which case it may include the components of the RX path, but not the components of the TX path; or the RF device 2200 may be an RF device supporting only wireless transmission (e.g., an RF transmitter), in which case it may include the components of the TX path, but not the components of the RX path.

In some embodiments, some or all of the components included in the RF device 2200 may be attached to one or more motherboards. In some embodiments, some or all of these components are fabricated on a single die, e.g., on a single SOC die.

Additionally, in various embodiments, the RF device 2200 may not include one or more of the components illustrated in FIG. 10, but the RF device 2200 may include interface circuitry for coupling to the one or more components. For example, the RF device 2200 may not include an antenna 2202, but may include antenna interface circuitry (e.g., a matching circuitry, a connector and driver circuitry) to which an antenna 2202 may be coupled. In another set of examples, the RF device 2200 may not include a digital processing unit 2208 or a local oscillator 2206, but may include device interface circuitry (e.g., connectors and supporting circuitry) to which a digital processing unit 2208 or a local oscillator 2206 may be coupled.

As shown in FIG. 10, the RF device 2200 may include an antenna 2202, a duplexer 2204, a local oscillator 2206, a digital processing unit 2208. As also shown in FIG. 10, the RF device 2200 may include an RX path that may include an RX path amplifier 2212, an RX path pre-mix filter 2214, a RX path mixer 2216, an RX path post-mix filter 2218, and an ADC 2220. As further shown in FIG. 10, the RF device 2200 may include a TX path that may include a TX path amplifier 2222, a TX path post-mix filter 2224, a TX path mixer 2226, a TX path pre-mix filter 2228, and a DAC 2230. Still further, the RF device 2200 may further include an impedance tuner 2232, an RF switch 2234, and control logic 2236. In various embodiments, the RF device 2200 may include multiple instances of any of the components shown in FIG. 10. In some embodiments, the RX path amplifier 2212, the TX path amplifier 2222, the duplexer 2204, and the RF switch 2234 may be considered to form, or be a part of, an RF front-end (FE) of the RF device 2200. In some embodiments, the RX path amplifier 2212, the TX path amplifier 2222, the duplexer 2204, and the RF switch 2234 may be considered to form, or be a part of, an RF FE of the RF device 2200. In some embodiments, the RX path mixer 2216 and the TX path mixer 2226 (possibly with their associated pre-mix and post-mix filters shown in FIG. 10) may be considered to form, or be a part of, an RF transceiver of the RF device 2200 (or of an RF receiver or an RF transmitter if only RX path or TX path components, respectively, are included in the RF device 2200). In some embodiments, the RF device 2200 may further include one or more control logic elements/circuits, shown in FIG. 10 as control logic 2236, e.g., an RF FE control interface. In some embodiments, the control logic 2236 may be configured to control at least portions of operating a programmable radio timing controller, as described herein. In some embodiments, the control logic 2236 may be used to perform control other functions within the RF device 2200, e.g., enhance control of complex RF system environment, support implementation of envelope tracking techniques, reduce dissipated power, etc.

The antenna 2202 may be configured to wirelessly transmit and/or receive RF signals in accordance with any wireless standards or protocols, e.g., Wi-Fi, LTE, or GSM, as well as any other wireless protocols that are designated as 3G, 4G, 5G, and beyond. If the RF device 2200 is an FDD transceiver, the antenna 2202 may be configured for concurrent reception and transmission of communication signals in separate, i.e., non-overlapping and non-continuous, bands of frequencies, e.g., in bands having a separation of, e.g., 20 MHz from one another. If the RF device 2200 is a TDD transceiver, the antenna 2202 may be configured for sequential reception and transmission of communication signals in bands of frequencies that may be the same or overlapping for TX and RX paths. In some embodiments, the RF device 2200 may be a multi-band RF device, in which case the antenna 2202 may be configured for concurrent reception of signals having multiple RF components in separate frequency bands and/or configured for concurrent transmission of signals having multiple RF components in separate frequency bands. In such embodiments, the antenna 2202 may be a single wide-band antenna or a plurality of band-specific antennas (i.e., a plurality of antennas each configured to receive and/or transmit signals in a specific band of frequencies). In various embodiments, the antenna 2202 may include a plurality of antenna elements, e.g., a plurality of antenna elements forming a phased antenna array (i.e., a communication system or an array of antennas that may use a plurality of antenna elements and phase shifting to transmit and receive RF signals). Compared to a single-antenna system, a phased antenna array may offer advantages such as increased gain, ability of directional steering, and simultaneous communication. In some embodiments, the RF device 2200 may include more than one antenna 2202 to implement antenna diversity. In some such embodiments, the RF switch 2234 may be deployed to switch between different antennas.

An output of the antenna 2202 may be coupled to the input of the duplexer 2204. The duplexer 2204 may be any suitable component configured for filtering multiple signals to allow for bidirectional communication over a single path between the duplexer 2204 and the antenna 2202. The duplexer 2204 may be configured for providing RX signals to the RX path of the RF device 2200 and for receiving TX signals from the TX path of the RF device 2200.

The RF device 2200 may include one or more local oscillators 2206, configured to provide local oscillator signals that may be used for downconversion of the RF signals received by the antenna 2202 and/or upconversion of the signals to be transmitted by the antenna 2202.

The RF device 2200 may include the digital processing unit 2208, which may include one or more processing devices. In some embodiments, the digital processing unit 2208 may be implemented as the processing device 2102 shown in FIG. 9, descriptions of which are provided above. The digital processing unit 2208 may be configured to perform various functions related to digital processing of the RX and/or TX signals. Examples of such functions include, but are not limited to, decimation/downsampling, error correction, digital downconversion or upconversion, DC offset cancellation, automatic gain control, etc. Although not shown in FIG. 10, in some embodiments, the RF device 2200 may further include a memory device, e.g., the memory device 2104 as described with reference to FIG. 9, configured to cooperate with the digital processing unit 2208.

Turning to the details of the RX path that may be included in the RF device 2200, the RX path amplifier 2212 may include a low-noise amplifier (LNA). An input of the RX path amplifier 2212 may be coupled to an antenna port (not shown) of the antenna 2202, e.g., via the duplexer 2204. The RX path amplifier 2212 may amplify the RF signals received by the antenna 2202.

An output of the RX path amplifier 2212 may be coupled to an input of the RX path pre-mix filter 2214, which may be a harmonic or band-pass (e.g., low-pass) filter, configured to filter received RF signals that have been amplified by the RX path amplifier 2212.

An output of the RX path pre-mix filter 2214 may be coupled to an input of the RX path mixer 2216, also referred to as a downconverter. The RX path mixer 2216 may include two inputs and one output. A first input may be configured to receive the RX signals, which may be current signals, indicative of the signals received by the antenna 2202 (e.g., the first input may receive the output of the RX path pre-mix filter 2214). A second input may be configured to receive local oscillator signals from one of the local oscillators 2206. The RX path mixer 2216 may then mix the signals received at its two inputs to generate a downconverted RX signal, provided at an output of the RX path mixer 2216. As used herein, downconversion refers to a process of mixing a received RF signal with a local oscillator signal to generate a signal of a lower frequency. In particular, the TX path mixer (e.g., downconverter) 2216 may be configured to generate the sum and/or the difference frequency at the output port when two input frequencies are provided at the two input ports. In some embodiments, the RF device 2200 may implement a direct-conversion receiver (DCR), also known as homodyne, synchrodyne, or zero-IF receiver, in which case the RX path mixer 2216 may be configured to demodulate the incoming radio signals using local oscillator signals whose frequency is identical to, or close to the carrier frequency of the radio signal. In other embodiments, the RF device 2200 may make use of downconversion to an intermediate frequency (IF). IFs may be used in superheterodyne radio receivers, in which a received RF signal is shifted to an IF before the final detection of the information in the received signal is done. Conversion to an IF may be useful for several reasons. For example, when several stages of filters are used, they can all be set to a fixed frequency, which makes them easier to build and to tune. In some embodiments, the RX path mixer 2216 may include several such stages of IF conversion.

Although a single RX path mixer 2216 is shown in the RX path of FIG. 10, in some embodiments, the RX path mixer 2216 may be implemented as a quadrature downconverter, in which case it would include a first RX path mixer and a second RX path mixer. The first RX path mixer may be configured for performing downconversion to generate an in-phase (I) downconverted RX signal by mixing the RX signal received by the antenna 2202 and an in-phase component of the local oscillator signal provided by the local oscillator 2206. The second RX path mixer may be configured for performing downconversion to generate a quadrature (Q) downconverted RX signal by mixing the RX signal received by the antenna 2202 and a quadrature component of the local oscillator signal provided by the local oscillator 2206 (the quadrature component is a component that is offset, in phase, from the in-phase component of the local oscillator signal by 90 degrees). The output of the first RX path mixer may be provided to a I-signal path, and the output of the second RX path mixer may be provided to a Q-signal path, which may be substantially 90 degrees out of phase with the I-signal path.

The output of the RX path mixer 2216 may, optionally, be coupled to the RX path post-mix filter 2218, which may be low-pass filters. In case the RX path mixer 2216 is a quadrature mixer that implements the first and second mixers as described above, the in-phase and quadrature components provided at the outputs of the first and second mixers respectively may be coupled to respective individual first and second RX path post-mix filters included in the filter 2218.

The ADC 2220 may be configured to convert the mixed RX signals from the RX path mixer 2216 from analog to digital domain. The ADC 2220 may be a quadrature ADC that, similar to the RX path quadrature mixer 2216, may include two ADCs, configured to digitize the downconverted RX path signals separated in in-phase and quadrature components. The output of the ADC 2220 may be provided to the digital processing unit 2208, configured to perform various functions related to digital processing of the RX signals so that information encoded in the RX signals can be extracted.

Turning to the details of the TX path that may be included in the RF device 2200, the digital signal to later be transmitted (TX signal) by the antenna 2202 may be provided, from the digital processing unit 2208, to the DAC 2230. Similar to the ADC 2220, the DAC 2230 may include two DACs, configured to convert, respectively, digital I- and Q-path TX signal components to analog form.

Optionally, the output of the DAC 2230 may be coupled to the TX path pre-mix filter 2228, which may be a band-pass (e.g., low-pass) filter (or a pair of band-pass, e.g., low-pass, filters, in case of quadrature processing) configured to filter out, from the analog TX signals output by the DAC 2230, the signal components outside of the desired band. The digital TX signals may then be provided to the TX path mixer 2226, which may also be referred to as an upconverter. Similar to the RX path mixer 2216, the TX path mixer 2226 may include a pair of TX path mixers, for in-phase and quadrature component mixing. Similar to the first and second RX path mixers that may be included in the RX path, each of the TX path mixers of the TX path mixer 2226 may include two inputs and one output. A first input may receive the TX signal components, converted to the analog form by the respective DAC 2230, which are to be upconverted to generate RF signals to be transmitted. The first TX path mixer may generate an in-phase (I) upconverted signal by mixing the TX signal component converted to analog form by the DAC 2230 with the in-phase component of the TX path local oscillator signal provided from the local oscillator 2206 (in various embodiments, the local oscillator 2206 may include a plurality of different local oscillators, or be configured to provide different local oscillator frequencies for the mixer 2216 in the RX path and the mixer 2226 in the TX path). The second TX path mixer may generate a quadrature phase (Q) upconverted signal by mixing the TX signal component converted to analog form by the DAC 2230 with the quadrature component of the TX path local oscillator signal. The output of the second TX path mixer may be added to the output of the first TX path mixer to create a real RF signal. A second input of each of the TX path mixers may be coupled the local oscillator 2206.

Optionally, the RF device 2200 may include the TX path post-mix filter 2224, configured to filter the output of the TX path mixer 2226.

The TX path amplifier 2222 may be a power amplifier (PA), configured to amplify the upconverted RF signal before providing it to the antenna 2202 for transmission.

In various embodiments, any of the RX path pre-mix filter 2214, the RX path post-mix filter 2218, the TX post-mix filter 2224, and the TX pre-mix filter 2228 may be implemented as RF filters. In some embodiments, an RF filter may be implemented as a plurality of RF filters, or a filter bank. A filter bank may include a plurality of RF filters that may be coupled to a switch, e. g., the RF switch 2234, configured to selectively switch any one of the plurality of RF filters on and off (e.g., activate any one of the plurality of RF filters), in order to achieve desired filtering characteristics of the filter bank (i.e., in order to program the filter bank). For example, such a filter bank may be used to switch between different RF frequency ranges when the RF device 2200 is, or is included in, a BS or in a UE device. In another example, such a filter bank may be programmable to suppress TX leakage on the different duplex distances.

The impedance tuner 2232 may include any suitable circuitry, configured to match the input and output impedances of the different RF circuitries to minimize signal losses in the RF device 2200. For example, the impedance tuner 2232 may include an antenna impedance tuner. Being able to tune the impedance of the antenna 2202 may be particularly advantageous because antenna's impedance is a function of the environment that the RF device 2200 is in, e.g., antenna's impedance changes depending on, e.g., if the antenna is held in a hand, placed on a car roof, etc.

As described above, the RF switch 2234 may be a device configured to route high-frequency signals through transmission paths, e.g., in order to selectively switch between a plurality of instances of any one of the components shown in FIG. 10, e.g., to achieve desired behavior and characteristics of the RF device 2200. For example, in some embodiments, an RF switch may be used to switch between different antennas 2202. In other embodiments, an RF switch may be used to switch between a plurality of RF filters (e.g., by selectively switching RF filters on and off) of the RF device 2200. Typically, an RF system would include a plurality of such RF switches.

The RF device 2200 provides a simplified version and, in further embodiments, other components not specifically shown in FIG. 10 may be included. For example, the RX path of the RF device 2200 may include a current-to-voltage amplifier between the RX path mixer 2216 and the ADC 2220, which may be configured to amplify and convert the downconverted signals to voltage signals. In another example, the RX path of the RF device 2200 may include a balun transformer for generating balanced signals. In yet another example, the RF device 2200 may further include a clock generator, which may, e.g., include a suitable PLL, configured to receive a reference clock signal and use it to generate a different clock signal that may then be used for timing the operation of the ADC 2220, the DAC 2230, and/or that may also be used by the local oscillator 2206 to generate the local oscillator signals to be used in the RX path or the TX path.

Example Data Processing System

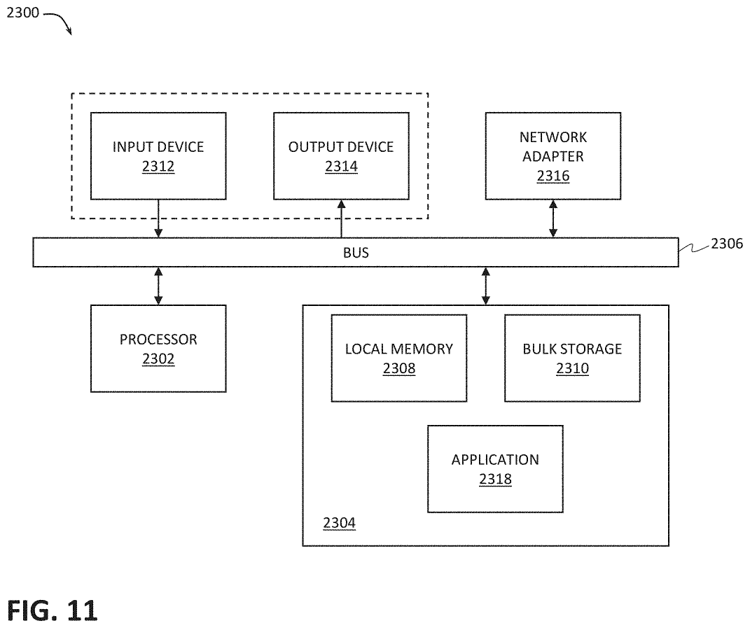

FIG. 11 provides a block diagram illustrating an example data processing system 2300 that may be configured to control operation of a programmable radio timing controller, according to some embodiments of the present disclosure. For example, the data processing system 2300 may be configured to implement or control portions of the system 200 and/or the device 500 as described herein. In some embodiments, the data processing system 2300 may be configured to implement the control logic 2236, shown in FIG. 10.

As shown in FIG. 11, the data processing system 2300 may include at least one processor 2302, e.g., a hardware processor 2302, coupled to memory elements 2304 through a system bus 2306. As such, the data processing system may store program code within memory elements 2304. Further, the processor 2302 may execute the program code accessed from the memory elements 2304 via a system bus 2306. In one aspect, the data processing system may be implemented as a computer that is suitable for storing and/or executing program code. It should be appreciated, however, that the data processing system 2300 may be implemented in the form of any system including a processor and a memory that is capable of performing the functions described within this disclosure.

In some embodiments, the processor 2302 can execute software or an algorithm to perform the activities as discussed in the present disclosure, in particular activities related to a programmable radio timing controller, as described herein. The processor 2302 may include any combination of hardware, software, or firmware providing programmable logic, including by way of non-limiting example a microprocessor, a DSP, a field-programmable gate array (FPGA), a programmable logic array (PLA), an application-specific IC (ASIC), or a virtual machine processor. The processor 2302 may be communicatively coupled to the memory element 2304, for example in a direct-memory access (DMA) configuration, so that the processor 2302 may read from or write to the memory elements 2304.

In general, the memory elements 2304 may include any suitable volatile or non-volatile memory technology, including double data rate (DDR) RAM, synchronous RAM (SRAM), dynamic RAM (DRAM), flash, ROM, optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the data processing system 2300 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in the present figures, e.g., any elements of system 200 and/or the device 500, can also include suitable interfaces for receiving, transmitting, and/or otherwise communicating data or information in a network environment so that they can communicate with, e.g., the data processing system 2300.

In certain example implementations, mechanisms for realizing a programmable radio timing controller as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as the memory elements 2304 shown in FIG. 11, can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as the processor 2302 shown in FIG. 11, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 2304 may include one or more physical memory devices such as, for example, local memory 2308 and one or more bulk storage devices 2310. The local memory may refer to RAM or other non-persistent memory device(s) generally used during actual execution of the program code. A bulk storage device may be implemented as a hard drive or other persistent data storage device. The processing system 2300 may also include one or more cache memories (not shown) that provide temporary storage of at least some program code in order to reduce the number of times program code must be retrieved from the bulk storage device 2310 during execution.

As shown in FIG. 11, the memory elements 2304 may store an application 2318. In various embodiments, the application 2318 may be stored in the local memory 2308, the one or more bulk storage devices 2310, or apart from the local memory and the bulk storage devices. It should be appreciated that the data processing system 2300 may further execute an operating system (not shown in FIG. 11) that can facilitate execution of the application 2318. The application 2318, being implemented in the form of executable program code, can be executed by the data processing system 2300, e.g., by the processor 2302. Responsive to executing the application, the data processing system 2300 may be configured to perform one or more operations or method steps described herein.

Input/output (I/O) devices depicted as an input device 2312 and an output device 2314, optionally, can be coupled to the data processing system. Examples of input devices may include, but are not limited to, a keyboard, a pointing device such as a mouse, or the like. Examples of output devices may include, but are not limited to, a monitor or a display, speakers, or the like. In some embodiments, the output device 2314 may be any type of screen display, such as plasma display, LCD, organic light-emitting diode (OLED) display, electroluminescent (EL) display, or any other indicator, such as a dial, barometer, or LEDs. In some implementations, the system may include a driver (not shown) for the output device 2314. Input and/or output devices 2312, 2314 may be coupled to the data processing system either directly or through intervening I/O controllers.

In an embodiment, the input and the output devices may be implemented as a combined input/output device (illustrated in FIG. 11 with a dashed line surrounding the input device 2312 and the output device 2314). An example of such a combined device is a touch sensitive display, also sometimes referred to as a “touch screen display” or simply “touch screen”. In such an embodiment, input to the device may be provided by a movement of a physical object, such as a stylus or a finger of a user, on or near the touch screen display.

A network adapter 2316 may also, optionally, be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 2300, and a data transmitter for transmitting data from the data processing system 2300 to said systems, devices and/or networks. Modems, cable modems, and Ethernet cards are examples of different types of network adapter that may be used with the data processing system 2300.

Variations and Implementations

While embodiments of the present disclosure were described above with references to exemplary implementations as shown in FIGS. 2-8, a person skilled in the art will realize that the various teachings described above are applicable to a large variety of other implementations.

In the discussions of the embodiments above, components of a system, such as e.g., combiners/adders, flip-flops, multiplexers, and/or other components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure related to a programmable radio timing controller.

Parts of a programmable radio timing controller as proposed herein can include electronic circuitry to perform the functions described herein. In some cases, one or more parts of the system can be provided by a processor specially configured for carrying out the functions described herein. For instance, the processor may include one or more application-specific components, or may include programmable logic gates which are configured to carry out the functions describe herein. The circuitry can operate in analog domain, digital domain, or in a mixed-signal domain. In some instances, the processor may be configured to carrying out the functions described herein by executing one or more instructions stored on a non-transitory computer-readable storage medium.

In some embodiments, any number of electrical circuits of the present figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of DSPs, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In some embodiments, the electrical circuits of the present figures may be implemented as stand-alone modules (e.g., a device with associated components and circuitry configured to perform a specific application or function) or implemented as plug-in modules into application-specific hardware of electronic devices. Note that particular embodiments of the present disclosure may be readily included in a SOC package, either in part, or in whole. An SOC represents an IC that integrates components of a computer or other electronic system into a single chip. It may contain digital, analog, mixed-signal, and often RF functions: all of which may be provided on a single chip substrate. Other embodiments may include a multi-chip-module (MCM), with a plurality of separate ICs located within a single electronic package and configured to interact closely with each other through the electronic package.

All of the specifications, dimensions, and relationships outlined herein (e.g., the number of components of the various devices and systems related to a programmable radio timing controller, or portions of such devices and systems, shown in the present drawings, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the present drawings may be combined in various possible configurations, all of which are clearly within the broad scope of the present disclosure. In certain cases, it may be easier to describe one or more of the functionalities of a given set of flows by only referencing a limited number of electrical elements. It should be appreciated that the electrical circuits of the present figures and its teachings are readily scalable and can accommodate a large number of components, as well as more complicated or sophisticated arrangements and configurations. Accordingly, the examples provided should not limit the scope or inhibit the broad teachings of the electrical circuits as potentially applied to a myriad of other architectures.

Furthermore, functions related to a programmable radio timing controller as proposed herein illustrate only some of the possible functions that may be executed by, or within, system illustrated in the present figures. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Note that all optional features of the apparatus described above may also be implemented with respect to the method or process described herein and specifics in the examples may be used anywhere in one or more embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

1. A radio timing controller, comprising:
a radio control interface; and
one or more sequence controllers, coupled to the radio control interface, and configured to program one or more features of the radio timing controller.

2. The radio timing controller according to claim 1, wherein the one or more features include one or more of:
a number of general purpose inputs and outputs (GPIOs),
mapping of the GPIOs to one or more radio controls, and
a sequence to set a radio control output state.
